(19) United States
(12) Patent Application Publication
(10) Pub. No.: US 2012/0077657 A1
(43) Pub. Date: Mar. 29, 2012

(54) PROTECTIVE FILM AND ROLLER USING THE SAME

(75) Inventors: TAI-CHERNG YU, Tu-Cheng (TW); DA-WEI LIN, Tu-Cheng (TW)

(73) Assignee: HON HAI PRECISION INDUSTRY CO., LTD., Tu-Cheng (TW)

(21) Appl. No.: 12/947,835

(22) Filed: Nov. 17, 2010

(30) Foreign Application Priority Data
Sep. 29, 2010 (TW) 99133170

(51) Int. Cl. F16C 13/00

(52) U.S. Cl. 492/49

(57) ABSTRACT

A protective film includes an adhesive layer, a metal nitride layer, and an anti-adhesive layer. The metal nitride layer is coated on the adhesive layer. The anti-adhesive layer is coated on the metal nitride layer.

### BACKGROUND

1. Technical Field

The present disclosure relates to a protective film and a roller having the protective film.

2. Description of Related Art

A roll to roll process has been used for forming an ultra-thin light guiding board and a copper coated steel tube has been adopted in the roll to roll process. However, the copper coating easily rusts, and the oxidized copper coating may attract UV adhesive in the roll to roll process. In addition, the copper is a soft metal, and fine cracks may form in the surface of the copper coating during the roll to roll process. Thus, the roller needs to be frequently replaced to ensure the surface accuracy of the ultra-thin light guiding board.

What is needed, therefore, is a protective film and a roller using the same to overcome the above-described problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a sectional view of a roller having a protective film according to an exemplary embodiment.

FIG. 2 is an enlarged view of the protective film of the roller of FIG. 1.

### DETAILED DESCRIPTION

Embodiments of the present disclosure will now be described in detail below, with reference to the accompanying drawings.

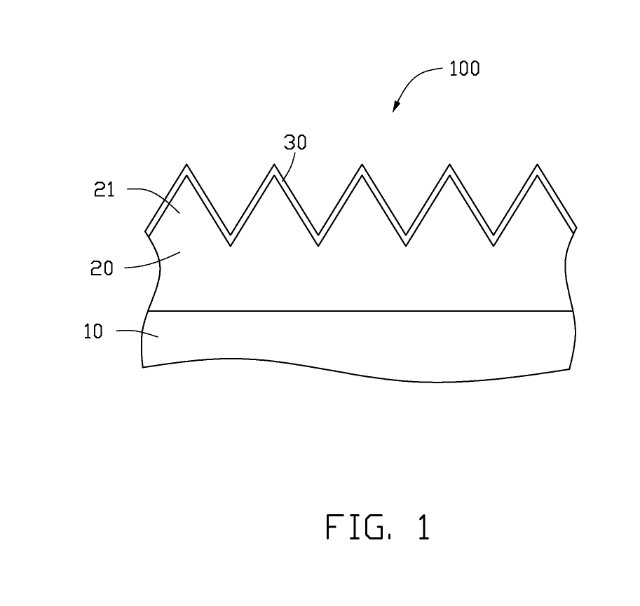

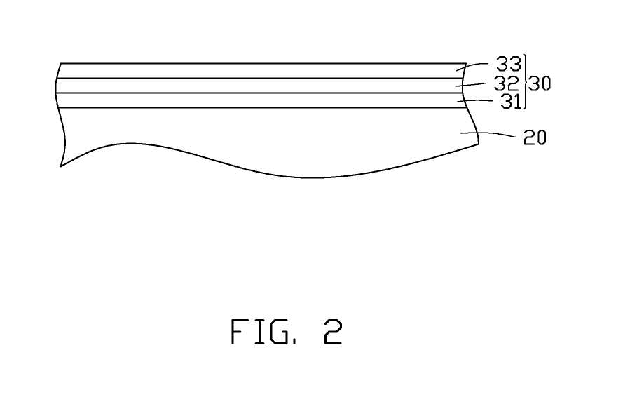

Referring to FIGS. 1 and 2, a roller 100, according to an exemplary embodiment, is shown. The roller 100 is used for forming an ultra-thin light guiding board (not shown). The roller 100 includes a barrel 10, a copper coating 20, and a protective film 30.

The barrel 10 is a stainless steel seamless tube. The copper coating 20 is coated on the outer surface of the barrel 10. The copper coating 20 forms a number of micro-structures 21 for forming the surface of the ultra-thin light guiding board.

The protective film 30 includes an adhesive layer 31, a metal nitride layer 32, and an anti-adhesive layer 33.

The protective film 30 is enlarged in the FIG. 2. The adhesion ability of copper is bad. Thus, the adhesive layer 31 is adopted to prevent the protective film 30 peeling off from the copper coating 20. The adhesive layer 31 is directly formed on the copper coating 20. The adhesive layer 31 can be made from nickel or cobalt alloy. In the present embodiment, the adhesive layer 31 is made from nickel.

The metal nitride layer 32 is coated on the adhesive layer 31. The metal nitride layer 32 is used for promoting the hardness and abrasion resistance of the surface of the roller 100, thus to prevent formation of cracks in the surface of the roller 100 from use. The metal nitride layer 32 can be a TiCN coating or a CrN coating. In the present embodiment, the metal nitride layer 32 is a TiCN coating, and is deposited using a PVD process.

The anti-adhesive layer 33 is coated on the metal nitride layer 32. The anti-adhesive layer 33 is used for preventing UV adhesive adhering to the surface of the roller 100. The anti-adhesive layer 33 can be a diamond-like-carbon (DLC) layer or a polytetrafluoroethene layer. In the present embodiment, the anti-adhesive layer 33 is a DLC layer, and is deposited using a CVD process.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A protective film comprising:
an adhesive layer;
a metal nitride layer coated on the adhesive layer; and
an anti-adhesive layer coated on the metal nitride layer.

2. The protective film as claimed in claim 1, wherein the adhesive layer is made from nickel or cobalt alloy.

3. The protective film as claimed in claim 1, wherein the metal nitride layer is made from one of TiCN and CrN.

4. The protective film as claimed in claim 1, wherein the metal nitride layer is deposited by using a PVD process.

5. The protective film as claimed in claim 1, wherein the anti-adhesive layer is made from one of diamond-like-carbon and polytetrafluoroethene.

6. The protective film as claimed in claim 1, wherein the metal nitride layer is deposited by a using a CVD process.

7. A roller comprising:
a barrel;
a copper coating comprising a plurality of micro-structures for forming a surface of a light-guiding board, the copper coating coated on a surface of the barrel; and
a protective film comprising an adhesive layer coated on the copper coating, a metal nitride layer coated on the adhesive layer, and an anti-adhesive layer coated on the metal nitride layer.

8. The roller as claimed in claim 7, wherein the adhesive layer is made from one of cobalt alloy and TiCN.

9. The roller as claimed in claim 7, wherein the metal nitride layer is made from CrN.

10. The roller as claimed in claim 7, wherein the metal nitride layer is deposited by using a PVD process.

11. The roller as claimed in claim 7, wherein the anti-adhesive layer is made from one of diamond-like-carbon and polytetrafluoroethene.

12. The roller as claimed in claim 7, wherein the metal nitride layer is deposited by using a CVD process.
